(19) United States
(12) Patent Application Publication
(10) Pub. No.: US 2023/0259374 A1
(43) Pub. Date: Aug. 17, 2023

(54) TASK-ORIENTED USER GUIDANCE

(71) Applicant: INTERNATIONAL BUSINESS MACHINES CORPORATION, Armonk, NY (US)

(72) Inventors: Qing Hua Feng, Beijing (CN); Cheng Fang Wang, Beijing (CN); Qing Song Yang, Beijing (CN); Jin Jin Yang, Beijing (CN); Si Ming NZ Zhu, Beijing (CN); Jia Yu, Beijing (CN)

(21) Appl. No.: 17/651,284

(22) Filed: Feb. 16, 2022

(51) Int. Cl. G06F 9/451; G06F 16/958; G06F 40/40

(52) U.S. Cl. CPC G06F 9/453; G06F 16/958; G06F 40/40

(57) ABSTRACT

An approach for the task-oriented user guidance is provided. The approach comprises receiving a query from a user to accomplish a task utilizing an application. The approach comprises determining one or more related pages of the application, wherein one or more keywords of the one or more related pages of the application match with one or more keywords of the query. The approach further comprises determining possible paths passing the one or more related pages of the application based on page relationship of the application. The approach further comprises determining one or more paths from the possible paths according to weights of the paths. The approach further comprises presenting the one or more paths to the user. The keywords of the page, the page relationship and the weights of the paths are determined based on page information of the application.

### BACKGROUND

The present invention relates to computer technologies and more particularly, to a method, system, and computer program product for generating a task-oriented user guidance dynamically for a user who need help to accomplish a task utilizing an application.

With the development of information technology, more and more applications may be utilized by users with computers or mobile phones in daily life and work. For example, the users may rely on mobile applications for many tasks, such as buying air tickets, booking hotels, and so on. With the development of business and technology and the diversification of requirements, applications are becoming more and more powerful and complicated. There are challenges to utilize the application to accomplish a task for the users.

### SUMMARY

Embodiments of the present disclosure disclose computer-implemented methods, systems and computer program products. According to some embodiments of the present disclosure, the computer-implemented method comprises receiving, by one or more processors, a query from a user to accomplish a task utilizing an application. The computer-implemented method comprises determining, by one or more processors, one or more related pages of the application, wherein one or more keywords of the one or more related pages of the application match with one or more keywords of the query. The computer-implemented method further comprises determining, by one or more processors, possible paths passing the one or more related pages of the application based on page relationship of the application. The computer-implemented method further comprises determining, by one or more processors, one or more paths from the possible paths according to weights of the paths. The computer-implemented method further comprises presenting, by one or more processors, the one or more paths to the user, wherein the keywords of the page, the page relationship and the weights of the paths are determined based on page information of the application.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure. Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a cloud computing node according to some embodiments of the present disclosure.

FIG. 2 depicts a cloud computing environment according to some embodiments of the present disclosure.

FIG. 3 depicts abstraction model layers according to some embodiments of the present disclosure.

FIG. 4A depicts an example page of an application according to embodiments of the present invention.

FIG. 4B depicts an example UI of the generated task-oriented user guidance dynamically according to embodiments of the present invention.

FIG. 5 depicts an example task-oriented user guidance system 500 according to embodiments of the present invention.

FIG. 6A depicts an example flow chart of a method of creating page information for each page of the application according to embodiments of the present invention.

FIG. 6B depicts an example data structure of page information for a page of the application according to embodiments of the present invention.

FIG. 6C depicts a schematic diagram of a defined page relationship map based on the page information of the application according to embodiments of the present invention.

FIG. 7 depicts an example flow chart of a method of determining one or more related nodes based on the page relationship map according to embodiments of the present invention.

FIG. 8A depicts an example flow chart of a method of recommending one or more paths according to weights of the paths based on the page relationship map according to embodiments of the present invention.

FIG. 8B depicts a schematic diagram of possible paths covering one or more related nodes starting from the current node to a last related node based on the page relationship map of the application according to embodiments of the present invention.

FIG. 9 depicts an example flow chart of a method 900 for the task-oriented user guidance according to embodiments of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly level out and rapidly released to quickly level in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

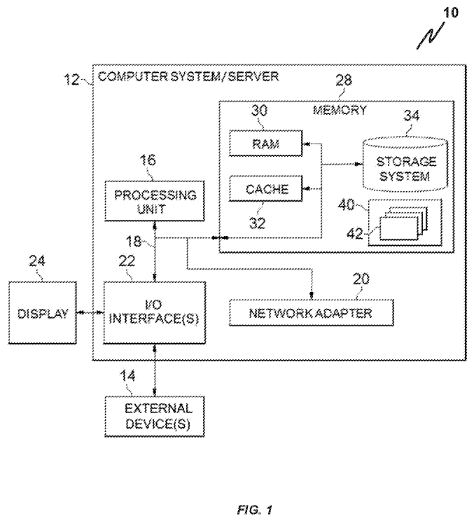

Referring now to FIG. 1, a schematic of an example of a cloud computing node is shown, according to some embodiments of the present disclosure. Cloud computing node 10 is only one example of a suitable cloud computing node and is not intended to suggest any limitation as to the scope of use or functionality of embodiments of the disclosure described herein. Regardless, cloud computing node 10 is capable of implementing and/or performing any of the functionality set forth herein.

In cloud computing node 10 there is a computer system/server 12, which can be a portable electronic device such as a communication device, and/or numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processing unit 16.

Bus 18 represents one or more of any of several types of bus structures, including a memory bus or memory controller, a peripheral bus, an accelerated graphics port, and a processor bus or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product 40 having a set (e.g., at least one) of program modules 42 that are configured to carry out the functions of embodiments of the disclosure.

Program product 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device, and a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

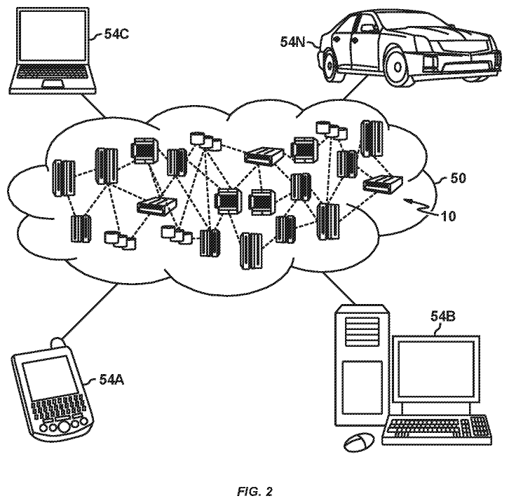

Referring now to FIG. 2, illustrative cloud computing environment 50 is depicted, according to some embodiments of the present disclosure. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

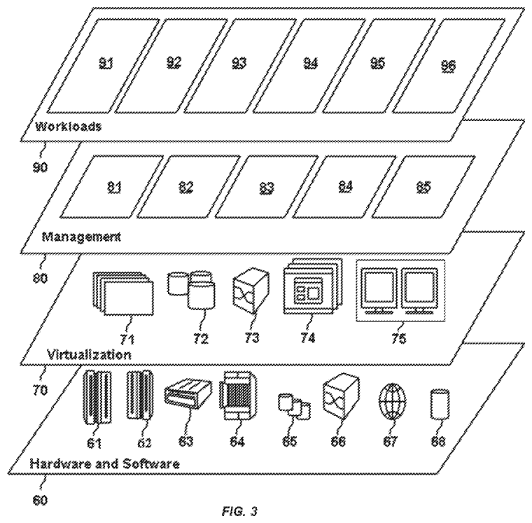

Referring now to FIG. 3, a set of functional abstraction layers provided by cloud computing environment 50 (FIG. 2) is shown, according to some embodiments of the present disclosure. It should be understood in advance that the components, layers, and functions shown in FIG. 3 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and accomplishment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and task-oriented user guidance 96. The functionalities of task-oriented user guidance 96 will be described in the following embodiment of the present disclosure.

As mentioned above, with the development of business and technology, applications are becoming more and more powerful and complicated. There are challenges to utilize the application to accomplish a task for the users. To assistant the users, for most of applications, there may be a help system. Normally, the help system may get some frequently asked questions prepared with predefined answers. When the users look for help, the help system may present the most related questions for the users to select and provide corresponding answer. Normally, the questions and corresponding answers are predefined and static. The help system may not provide useful guidance to the user based on what the user wants to accomplish in each situation. At the same time, the help system may generally focus on specific pages, keywords or functions of the application, rather than a task description that the user wants to accomplish in nature language. This leaves the users at a loss if the users are not familiar with the specific pages, keywords or functions of the application. Therefore the help system may not well address users' problems and there is a need to provide the users with an operable guidance to accomplish a task in each situation and allowing the users to input the questions in nature language.

According to example embodiments of the present disclosure, there is proposed a solution for generating an operable guidance dynamically once the user inputs a query to accomplish a task. As used herein, the “task” may refer to the goal that the user would like to achieve in nature language. The operable guidance may be, for example, an operation path comprising steps to accomplish the task. This will reduce the user's learning time and help the user to complete the task more effectively. At the same time, the solution allows the user to provide the query in nature language, instead of specific pages, keywords, functions or terms of the application. Therefore the proposed solution is a task-oriented solution, instead of function-oriented solution. It is friendly to users who are not familiar with the functions or terms of the application.

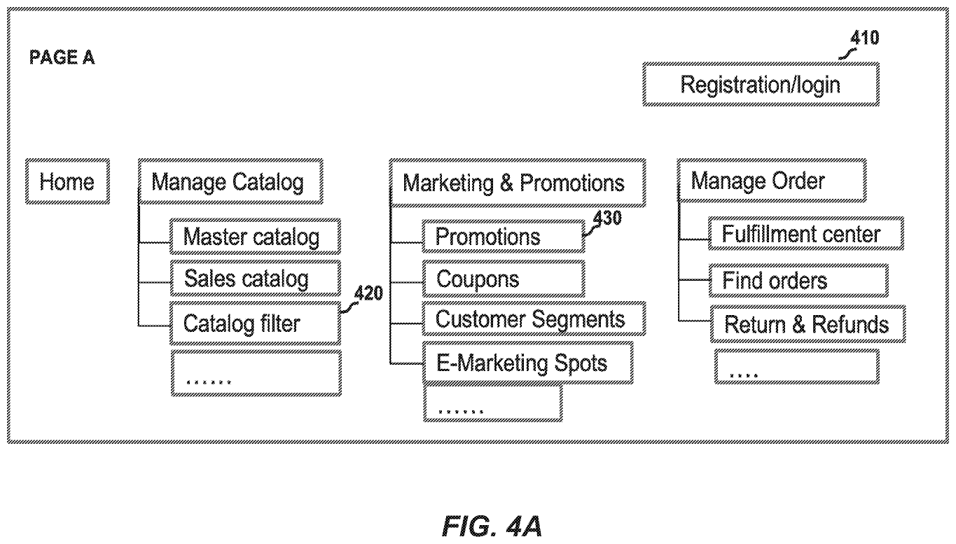

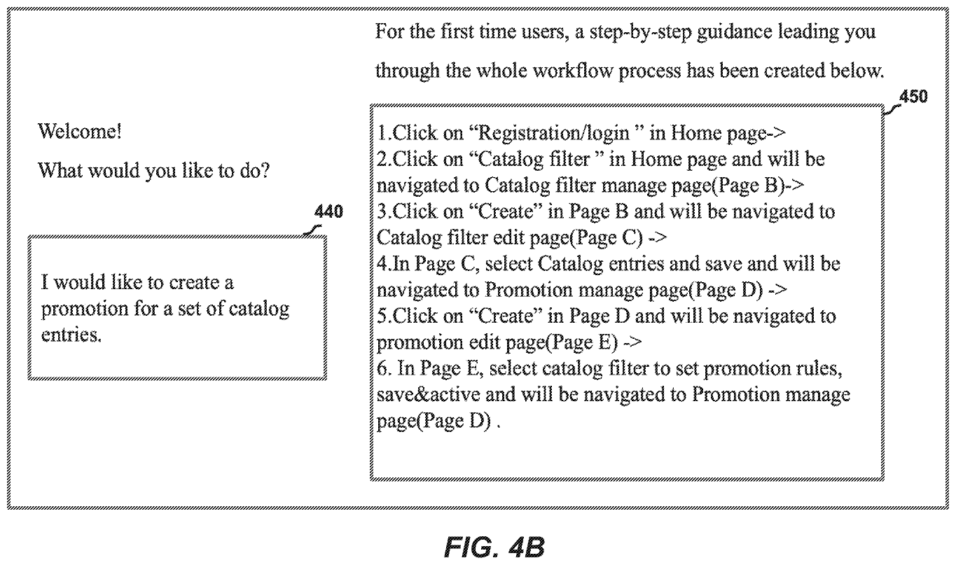

Now referring to FIG. 4A, which depicts an example page of an application. The application may be an example scenario regarding a management page of an e-commerce platform. In the example scenario, the user of the platform needs to manage catalogs of the products, sales promotion, orders and so on. Assuming the user has a task to create sales promotion for a set of catalog entries. The user may open the home page of the application shown in FIG. 4A. In the example web page, some function buttons are provided to facilitate users to handle business online. For example, the function buttons may include the button “Registration/login” 410, the button “Catalog filter” 420, the button “Promotions” 430 and so on. These buttons are distributed in the page of the application. The user may not know how to accomplish the task with the distributed buttons.

Now referring to FIG. 4B, which depicts an example UI of the generated task-oriented user guidance dynamically according to embodiments of the present disclosure. Assuming the user has a task to create sales promotion for a set of catalog entries. The user may input a query regarding the task. For example, the user may input a query “I would like to create a promotion for a set of catalog entries” in home page, as shown in 440. The task can be entered manually or selected by the user in the way of questionnaire, which is not limited herein. Then according to the proposed solution, an example guidance as shown in 450 will be generated based on the input. For example, the guidance may be presented in the form of pop-up windows, which is not limited herein. According to the guidance, the user may be guided to accomplish the task step by step. This guidance is created based on the input as shown in 440 dynamically. Thus the proposed solution may provide a way for the user to ask the application for directions on how to accomplish a specific task dynamically.

It is to be understood that the example page shown in FIG. 4A and the example UI of the generated task-oriented user guidance in FIG. 4B are provided for illustrative purpose only without suggesting any limitation as to the scope of the present disclosure.

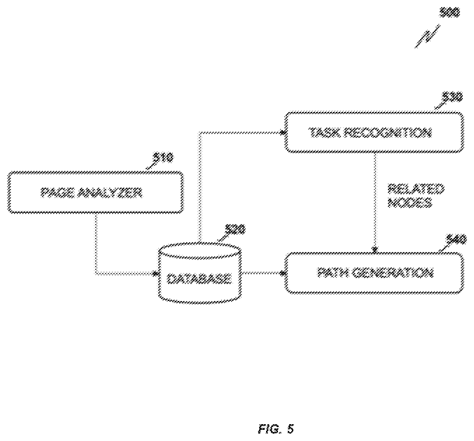

This proposed solution may be implemented by a task-oriented user guidance system, for example, an example task-oriented user guidance system 500 depicted in FIG. 5.

With reference now to FIG. 5, which depicts a schematic diagram of the example task-oriented user guidance system 500 according to embodiments of the present invention. The task-oriented user guidance system 500 may be implemented in software, hardware, firmware, and/or any combination thereof.

As illustrated in FIG. 5, the example task-oriented user guidance system 500 may include a page analyzer module 510, a database 520, a task recognition module 530 and a path generation module 540. It would be appreciated that the task-oriented user guidance system 500 is merely provided as a specific example, and the number of modules depicted in the FIG. 5 is merely shown for the purpose of illustration without implying any limitation. In other examples, a different number of modules may work together to provide a similar function or intention.

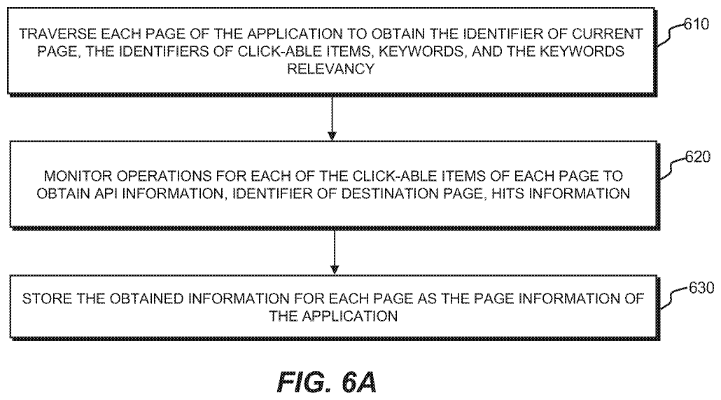

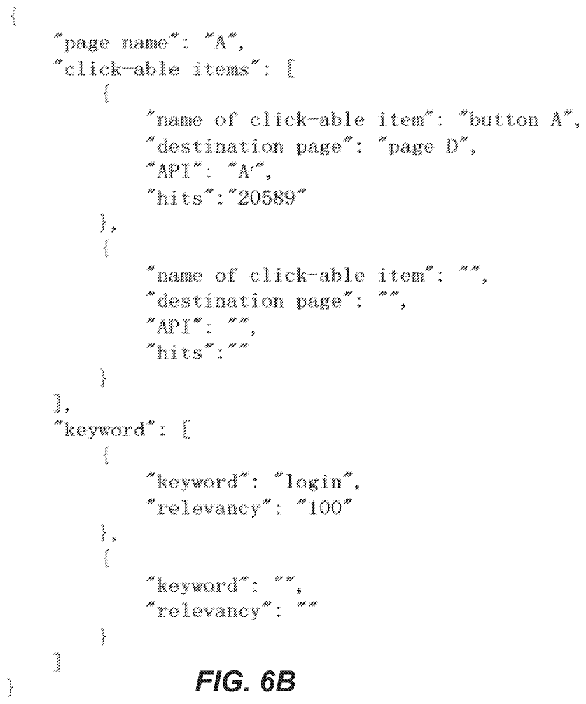

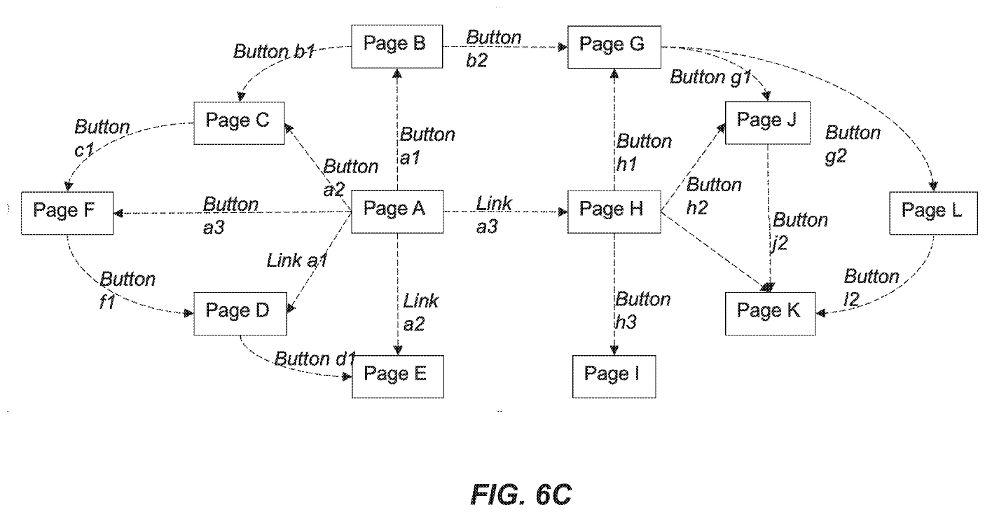

According to embodiments of the present disclosure, the page analyzer module 510 may be configured to obtain page information of each page of the application. The page may refer to a web page or a page of an application, collectively referred to as a page of an application for simplicity herein. The page information of each page of the application may comprise identifier of current page, keywords, keywords relevancy, identifiers of click-able items, API information triggered by performing the corresponding click-able item, identifier of destination page after performing the corresponding click-able item, hits information to the corresponding click-able item and so on. The method of creating the page information for each page of the application will be discussed in detail below in conjunction with FIG. 6A. The obtained page information of each page of the application may be stored in the database 520 as a data structure. An example data structure of page information for a page of the application may be shown in FIG. 6B. A page relationship map may be defined based on the obtained page information. A schematic diagram of the defined page relationship map is depicted in FIG. 6C. FIG. 6A-6C will be further discussed in the following.

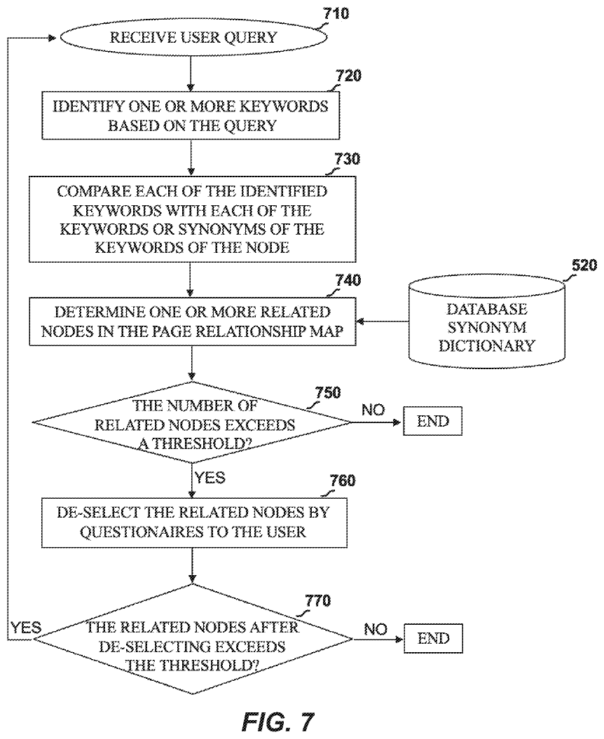

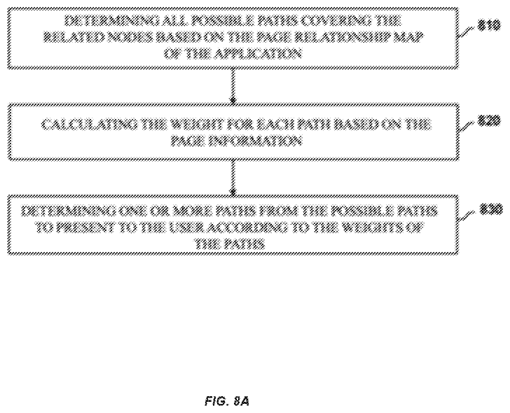

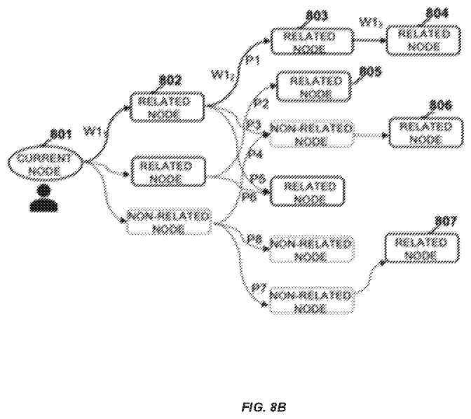

Back to FIG. 5, according to embodiments of the present disclosure, the task recognition module 530 may be configured to determine one or more related pages of the application based on a match between one or more keywords of the page of the application and one or more keywords of the query. The method of determining one or more related pages of the application will be discussed in detail below in conjunction with FIG. 7. The path generation module 540 may be configured to recommend one or more paths according to the weights of the paths to accomplish the task to the user. The method of recommending one or more paths according to the weights of the paths will be discussed in detail below in conjunction with FIG. 8A. The method of calculation of weight will be discussed in detail below in conjunction with FIG. 8B.

The above modules in FIG. 5 may be discussed in detail in the following in combination with FIGS. 6A-9.

With reference now to FIG. 6A, which depicts a flow chart of obtaining page information for each page of the application according to embodiments of the present invention. At the operation 610, the page analyzer module 510 may traverse each page of the application to obtain the identifier of current page, the identifiers of click-able items, the keywords and keywords relevancy. The click-able items comprise buttons, links and so on. The identifiers of click-able items may be “button a1”, “button b1”, “link a1” and so on.

At the operation 620, the page analyzer module 510 may monitor the operations of click-able items of each page of the application to obtain API information triggered by performing each of the click-able items, destination pages information after performing the click-able item and hits information to each of the click-able items during runtime.

The page analyzer module 510 may traverse and iterate automatically all pages of the application to obtain the page information for each page of the application. The page analyzer module 510 may utilize an automatic website traversal tool, for example, by AppCrawler, to traverse each page of the application. At the same time, the AppCrawler may cooperate with a network request monitor, for example, Fiddler, to monitor the operations of click-able items of each page of the application to obtain API information triggered by performing each of the click-able items, destination pages information after performing the click-able item and hits information to each of the click-able items. The page analyzer module 510 may also obtain the page information by checking log files. At the operation 630, the database 520 may store the obtained information for each page as the page information of the application.

In this way, the page information for each page of the application may be collected incrementally and stored into the database 520 for future use. It is to be understood that the tools or algorithms mentioned herein are only for illustration purpose. The approach of obtaining page information may utilize any other appropriate tool or algorithm existing nowadays or developed in the future and should not adversely limit the scope of the invention.

According to embodiments of the present disclosure, an example data structure of page information for a page of the application may be shown in FIG. 6B. As illustrated in FIG. 6B, the page information is for “page A”, and the identifier of one of the click-able items is “button A”. The identifier of “destination page” of “button A” is “Page D”. The “API” triggered by “button A” is “A′”. And the number of “hits” to “button A” performed by the history users is “20589”. The keyword is “login” and the “relevancy” of the keyword “login” is “100”.

It is to be understood that the page information shown in FIG. 6B is only for illustration purpose. The page information is stored in a JSON file as shown in FIG. 6B. It is to be understood that the page information may be stored in any other type of data structure. The manner of storage for the page information should not adversely limit the scope of the invention.

According to embodiments of the present disclosure, the page analyzer module 510 may define a page relationship map based on the page information stored in the database 520, The schematic diagram of the page relationship map based on the page information of the application according to embodiments of the present invention may be shown in FIG. 6C.

With reference now to FIG. 6C, each page of the application corresponds to a node of the page relationship map. The nodes of the page relationship map are connected to each other by the edges. Each of the edges corresponds to a function button or link in the page of the application. For example, Page F is connected to Page C by button cl, that is, when the user clicks button cl, the corresponding API (which is not shown) will be triggered and the user may be navigated from page C to page F. The page F is the destination page after clicking button cl. It is to be understood that each clicking operation will trigger the corresponding API. Each of edge may comprise hits information to corresponding clickable-item. The API information and the hits information are not shown in FIG. 6C for simplification purpose. It is to be understood that the page relationship map of the application in practice is complex, and the page relationship map of FIG. 6C is only shown for illustration purpose.

With reference now to FIG. 7, which depicts a flow chart of determining one or more related nodes based on the page relationship map according to embodiments of the present invention. At the operation 710, the task recognition module 530 may receive the first query from the user. The input query may be in a natural language. At the operation 720, the task recognition module 530 may conduct a natural language analysis to identify one or more keywords based on the query. Taking the scenario shown in FIG. 4B as an example, once a query “I would like to create a promotion for a set of catalog entries” is received, the keywords “create”, “promotion”, and “catalog filter” may be identified. According to embodiments of the present disclosure, the database 520 may also comprise a synonym dictionary for the keywords of the page information of the application. The use of synonym dictionary of the keywords may expand the scope of the keywords stored in the database and improve accuracy and speed of matching. At the operation 730, the task recognition module 530 may compare each of the identified keywords from the query with each of the keywords or their synonyms of the node in the relationship map. At the operation 740, the task recognition module 530 may determine one or more related nodes in the page relationship map based on the condition that one or more keywords from the query match with one or more keyword of the node in the relationship map. That is, if at least one keyword from the query matches with at least one keyword of a node in the relationship map, the node in the relationship map may be a related node. Further, at the operation 750, the task recognition module 530 may determine whether the number of the determined related nodes exceeds a predefined threshold. If the determination result is no, then the process ends. If the determination result is yes, then the process goes to the operation 760. At the operation 760, the task recognition module 530 may ask the user by one or more questionnaire to de-select some inappropriate nodes from the determined related nodes. At the operation 770, the task recognition module 530 may determine whether the number of the related nodes after de-selecting exceeds the predefined threshold. If the determination result is no, then the process ends. If the determination result is yes, then the process goes back to the operation 710 and the task recognition module 530 may ask the user to input a second query to iterate the process.

With reference now to FIG. 8A, which depicts a flow chart of recommending one or more paths according to weights of the paths based on the relationship map according to embodiments of the present invention. As mentioned above, the path generation module 540 may be configured to recommend one or more paths to the user. At operation 810, the path generation module 540 may determine all possible paths covering one or more of the related nodes based on the page relationship map starting from the current node that the user is browsing to a last related node. The current node may be any one page including home page of the application. At operation 820, the path generation module 540 may calculate the weight of each path based on the page information stored in the database 520. At operation 830, the path generation module 540 may determine the one or more paths to present to the user according to the weights of the paths. The calculation approach of weights will be discussed in detail below in conjunction with FIG. 8B.

With reference now to FIG. 8B, which depicts a schematic diagram of possible paths covering one or more related nodes starting from the current node to a last related node based on the page relationship map of the application according to embodiments of the present invention. As illustrated in FIG. 8B, the node 801 is the current node, the nodes 804,805,806,807 are last nodes respectively. The solid line boxes represent related nodes, the dotted line boxes represent non-related nodes, each of the arrow lines corresponds to an edge, and a path is formed from the current node connected by the arrow line to next node, until to a last related node. In the example, there are 7 paths covering one or more of the related nodes starting from the current node to a last related node. They are P1, P2, P3, P4, P5, P6 and P7 respectively. As can be seen, the P8 does not belong to a possible path, since there is no related node covered by P8.

With reference now to FIG. 6C and FIG. 8B, it may be understood that each path comprises one or more nodes connected by one or more edges defined in the relationship map. Each node corresponds a page of the application. According to the direction of the arrow, a next node is the destination node of a previous node. Each edge between the two connected nodes corresponds to a specific clickable-item. By clicking the specific clickable-item, the user may be navigated from the previous node to the destination node. The previous node and the destination node are relative. A node may be a previous node of one node, it may also be a destination node of another node, and vice versa. Thus, the identifiers of the pages and clickable-items may be obtained based on the information of node and edge from each path, and further an operational guidance of clicking on which clickable-item on which page step by step may be obtained. That is, each path may represent the operational guidance of clicking on which clickable-item on which page step by step. The example operational guidance may be shown in FIG. 4B.

According to embodiments of the present disclosure, the weight of the path may be determined based on the number of related nodes covered by the path and weights of the edges comprised in the path. Assuming there are n edges in the path i, the edge i₁ is from node i₀ to node i₁ and the weight of edge i₁ is wi₁, the edge i₂ is from node i₁ to node i₂ and the weight of edge i₂ is wi₂ and so on. For example, for P1 shown in FIG. 8B, the edge 1₁ is from node 1₀ 801 to node 1₁ 802 and the weight of edge 1₁ is w1₁. The weight of the path i may be expressed by the following formula (1):

Weight of path i=f(wi₁,wi₂, . . . wiₙ)*factor of node number (1)

Herein, the factor of node number is the number of related nodes covered by the path i. The f(wi₁, wi₂, . . . wiₙ) may be expressed by the following formula (2):

f(wi₁,wi₂, . . . wiₙ)=Σₖ₌₁ⁿwiₖ (2)

As mentioned above, herein wi₁, wi₂, . . . wiₙ is corresponding to the weight of corresponding edge. The weight of corresponding edge may be determined based on the hits information to the corresponding clickable-item and keyword relevancy of the destination page. The wiₖ may be expressed by the following formula (3):

wiₖ=f(Hiₖ,Riₖ) (3)

Herein, Hiₖ is the ratio of the hits of the clickable-item corresponding to edge iₖ on the node i₍ₖ₋₁₎ to the sum of the hits of all items on the node i₍ₖ₋₁₎. Riₖ is the keyword relevancy of node iₖ.

It should be pointed out that the task-oriented user guidance system may obtain the operation information of the users in the runtime for the application, for example, the hits information to each of corresponding clickable-items. Thus the task-oriented user guidance system may record the behavior of the history users and recommend the operation path taken by most of the history users to accomplish a same or similar task to the users.

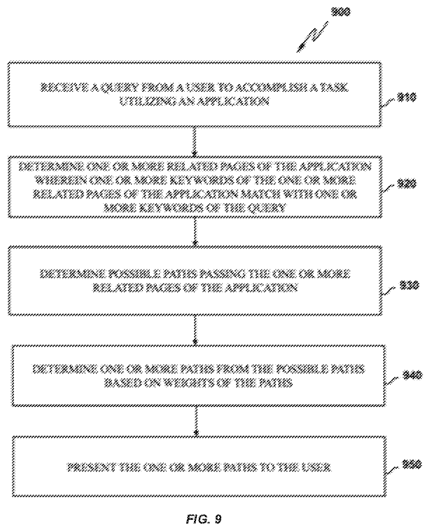

With reference now to FIG. 9, in which an example flow chart of a method 900 for the task-oriented user guidance according to embodiments of the present invention is depicted. The method 900 may comprise operations 910-950.

At the operation 910, the task recognition module 530 may receive a query from a user to accomplish a task utilizing an application.

At the operation 920, the task recognition module 530 may determine one or more related pages of the application, wherein one or more keywords of the one or more related pages of the application match with one or more keywords of the query.

At the operation 930, the path generation module 540 may determine possible paths passing the one or more related pages of the application starting from current page to the last page based on page relationship of the application.

At the operation 940, the path generation module 540 may determine one or more paths from the possible paths according to weights of the paths.

At the operation 950, the path generation module 540 may present the one or more paths to the user.

It should be noted that the task-oriented user guidance according to embodiments of this invention could be implemented by computer system/server 12 of FIG. 1.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. However, the various embodiments can be practiced without these specific details. In other instances, well-known circuits, structures, and techniques have not been shown in detail in order not to obscure embodiments.

What is claimed is:

1. A computer-implemented method performed by one or more processors, the method comprising:
receiving a query from a user to accomplish a task utilizing an application;
determining one or more related pages of the application, wherein one or more keywords of the one or more related pages of the application match with one or more keywords of the query;
determining possible paths passing the one or more related pages of the application based on page relationship of the application;
determining one or more paths from the possible paths according to weights of the paths; and
presenting the one or more paths to the user,
wherein the keywords of the page, the page relationship and the weights of the paths are determined based on page information of the application.

2. The computer-implemented method of claim 1, wherein the page information of the application comprises: identifier of current page, keywords, keywords relevancy, identifiers of click-able items, API information triggered by performing the corresponding click-able item, identifier of destination page after performing the corresponding click-able item and hits information to the corresponding click-able item.

3. The computer-implemented method of claim 2, wherein the page information of the application is created by:
traversing each page of the application to obtain the identifier of current page, the keywords, the keywords relevancy and the identifiers of the click-able items;
monitoring operations for each of the click-able items of each page of the application to obtain API information triggered by performing the corresponding click-able item, the identifier of destination page after performing the corresponding click-able item, and the hits information to the corresponding click-able item; and
storing the obtained information for each page of the application as the page information of the application in a database.

4. The computer-implemented method of claim 2, further comprising:
defining a page relationship map based on the page information of the application, wherein the page relationship map comprises nodes and edges, the nodes of the page relationship map are connected to each other by the edges, each of the nodes is corresponding to a page of the application, each of the edges is corresponding to a clickable-item in the page of the application and each of the edges contains the hits information to the corresponding clickable-item.

5. The computer-implemented method of claim 4, wherein the determining one or more related pages of the application comprising:
in response to receiving the query from the user, identifying one or more keywords from the query based on a natural language analysis to the query;
comparing each of the generated keywords with each of the keywords of each node of the page relationship map; and
determining one or more related node in the page relationship map, wherein one or more keywords of the one or more related nodes match with one or more keywords of the query.

6. The computer-implemented method of claim 4, the determining possible paths passing the one or more related pages of the application comprises:
determining all possible paths covering one or more related nodes based on the page relationship map of the application.

7. The computer-implemented method of claim 6, wherein the weight of the path is determined based on the number of related nodes covered by the path and weights of the edges comprised in the path, and the weight of each edge is determined based on the hits information to the corresponding clickable-item and the keyword relevancy of destination node.

8. A computer-implemented system, comprising:
at least one processing unit; and
a memory coupled to the at least one processing unit and storing instructions thereon, the instructions, when executed by the at least one processing unit, performing actions comprising:
receiving a query from a user to accomplish a task utilizing an application;
determining one or more related pages of the application, wherein one or more keywords of the one or more related pages of the application match with one or more keywords of the query;
determining possible paths passing the one or more related pages of the application based on page relationship of the application;
determining one or more paths from the possible paths according to weights of the paths; and
presenting the one or more paths to the user,
wherein the keywords of the page, the page relationship and the weights of the paths are determined based on page information of the application.

9. The computer-implemented system of claim 8, wherein the page information of the application comprises: identifier of current page, keywords, keywords relevancy, identifiers of click-able items, API information triggered by performing the corresponding click-able item, identifier of destination page after performing the corresponding click-able item and hits information to the corresponding click-able item.

10. The computer-implemented system of claim 9, wherein the page information of the application is created by:
traversing each page of the application to obtain the identifier of current page, the keywords, the keywords relevancy and the identifiers of the click-able items;
monitoring operations for each of the click-able items of each page of the application to obtain API information triggered by performing the corresponding click-able item, the identifier of destination page after performing the corresponding click-able item, and the hits information to the corresponding click-able item; and
storing the obtained information for each page of the application as the page information of the application in a database.

11. The computer-implemented system of claim 9, further comprising:
defining a page relationship map based on the page information of the application, wherein the page relationship map comprises nodes and edges, the nodes of the page relationship map are connected to each other by the edges, each of the nodes is corresponding to a page of the application, each of the edges is corresponding to a clickable-item in the page of the application and each of the edges contains the hits information to the corresponding clickable-item.

12. The computer-implemented system of claim 10, wherein the determining one or more related pages of the application comprising:
in response to receiving the query from the user, identifying one or more keywords from the query based on a natural language analysis to the query;
comparing each of the generated keywords with each of the keywords of each node of the page relationship map; and
determining one or more related node in the page relationship map, wherein one or more keywords of the one or more related nodes match with one or more keywords of the query.

13. The computer-implemented system of claim 10, the determining possible paths passing the one or more related pages of the application comprises:
determining all possible paths covering one or more related nodes based on the page relationship map of the application.

14. The computer-implemented system of claim 13, wherein the weight of the path is determined based on the number of related nodes covered by the path and weights of the edges comprised in the path, and the weight of each edge is determined based on the hits information to the corresponding clickable-item and the keyword relevancy of destination node.

15. A computer program product, the computer program product comprising a computer readable storage medium having program instructions embodied therewith, the program instructions executable by an electronic device to cause the electronic device to perform actions comprising:
receiving a query from a user to accomplish a task utilizing an application;
determining one or more related pages of the application, wherein one or more keywords of the one or more related pages of the application match with one or more keywords of the query;
determining possible paths passing the one or more related pages of the application based on page relationship of the application;
determining one or more paths from the possible paths according to weights of the paths; and
presenting the one or more paths to the user,
wherein the keywords of the page, the page relationship and the weights of the paths are determined based on page information of the application.

16. The computer program product of claim 15, wherein the page information of the application comprises: identifier of current page, keywords, keywords relevancy, identifiers of click-able items, API information triggered by performing the corresponding click-able item, identifier of destination page after performing the corresponding click-able item and hits information to the corresponding click-able item.

17. The computer program product of claim 16, wherein the page information of the application is created by:
traversing each page of the application to obtain the identifier of current page, the keywords, the keywords relevancy and the identifiers of the click-able items;
monitoring operations for each of the click-able items of each page of the application to obtain API information triggered by performing the corresponding click-able item, the identifier of destination page after performing the corresponding click-able item, and the hits information to the corresponding click-able item; and
storing the obtained information for each page of the application as the page information of the application in a database.

18. The computer program product of claim 16, further comprising:
defining a page relationship map based on the page information of the application, wherein the page relationship map comprises nodes and edges, the nodes of the page relationship map are connected to each other by the edges, each of the nodes is corresponding to a page of the application, each of the edges is corresponding to a clickable-item in the page of the application and each of the edges contains the hits information to the corresponding clickable-item.

19. The computer program product of claim 17, wherein the determining one or more related pages of the application comprising:
in response to receiving the query from the user, identifying one or more keywords from the query based on a natural language analysis to the query;
comparing each of the generated keywords with each of the keywords of each node of the page relationship map; and
determining one or more related node in the page relationship map, wherein one or more keywords of the one or more related nodes match with one or more keywords of the query.

20. The computer program product of claim 17, wherein the weight of the path is determined based on the number of related nodes covered by the path and weights of the edges comprised in the path, and the weight of each edge is determined based on the hits information to the corresponding clickable-item and the keyword relevancy of destination node.
